(19) United States
(12) Patent Application Publication
(10) Pub. No.: US 2025/0077691 A1
(43) Pub. Date: Mar. 6, 2025

(54) DETECTING SENSITIVE INFORMATION IN IMAGES

(71) Applicant: Cisco Technology, Inc., San Jose, CA (US)

(72) Inventor: Robert Armstrong Hanton, Rickmansworth (GB)

(21) Appl. No.: 18/456,613

(22) Filed: Aug. 28, 2023

(51) Int. Cl. G06F 21/62; G06N 7/01

(52) U.S. Cl. CPC G06F 21/6209; G06V 30/153

(57) ABSTRACT

A method of controlling the dissemination of sensitive information appearing in an image to be sent via electronic communication. The method includes determining a probability that an image selected to be sent with an electronic message includes sensitive information, and in response to the probability exceeding a predetermined threshold, applying a control measure to the image.

### TECHNICAL FIELD

The present disclosure relates to data security, and more particularly to techniques to identify or detect sensitive information that may be found in images such as photographs and to control the dissemination of such images.

### BACKGROUND

With the ubiquity and convenience of computers, smartphones, etc., it is very simple to send images, such as photographs, to people or groups using a wide range of messaging applications. Sending may be both one-to-one (1:1) and one-to-groups, whereupon the images could be available to the recipient(s) for an indefinite period, can be saved to another location, and/or can be shared with still further recipients.

Unfortunately, there are downsides to this convenience. Images may be sensitive for a variety of reasons. For example, they may contain nudity or other such content, or they may contain passwords or the like (e.g., sharing a photograph of a Wi-Fi password for convenience). The images could also be of important documents such as passports, medical documents, etc. Users may wittingly or unwittingly share images with individuals or groups without considering the ultimate or potential audience. For corporate messaging applications, sensitive images shared in this way may contravene data security policies and potentially increase a company's liability in lawsuits.

Even when applications have tools that can limit the actions a recipient can take with the image, or to limit the lifespan of the image, the sender may need to be aware that such options even exist, consider which option(s) might be applicable to the image they are sending, and then manually choose to apply such option(s) to the image(s).

### BRIEF DESCRIPTION OF THE DRAWINGS

FIG. 1 shows a network that interconnects a message sender, message recipients, and a server that may host image sensitivity detection and control logic, according to an example embodiment.

FIG. 2 is a flowchart illustrating a series of operations for detecting sensitive information in an image, according to an example embodiment.

FIG. 3 is a flowchart illustrating a series of operations for prompting a sender to apply control or security measures to an image being sent, according to an example embodiment.

FIG. 4 is a flowchart illustrating a series of operations executed by image sensitivity detection and control logic, according to an example embodiment.

FIG. 5 is a block diagram of a computing device that may be configured to execute image sensitivity detection and control logic and perform the techniques described herein, according to an example embodiment.

### DETAILED DESCRIPTION

### Overview

A method of controlling the dissemination of sensitive information appearing in an image to be sent via electronic communication. The method includes determining a probability that an image selected to be sent with an electronic message includes sensitive information, and in response to the probability exceeding a predetermined threshold, applying a control measure to the image.

In another embodiment, a device is provided. The device includes an interface configured to enable network communications, a memory, and one or more processors coupled to the interface and the memory, and configured to determine a probability that an image selected to be sent with an electronic message includes sensitive information, and in response to the probability exceeding a predetermined threshold, apply a control measure to the image.

### Example Embodiments

At a high level, the embodiments described herein detect that there is a high probability (i.e., above a predetermined threshold) that an image contains sensitive information while avoiding, as much as possible, delaying the user's (the sender's) ability to send the image via electronic communication. When a sufficiently high probability that sensitive information is present in the image, the methodology may automatically apply organizational controls, policies, and/or offer the sender a set of image recipient control options before the image is shared to a new location, whether via a messaging application or via automatic syncing to a separate storage location.

By executing this methodology automatically, users of messaging applications do not have to remember to manually apply special protections to their (potentially) sensitive images. Rather, the messaging application can be intuitive to use while still prompting a user to apply (or automatically applying) special protections or controls as appropriate, i.e., in accordance with a predetermined policy.

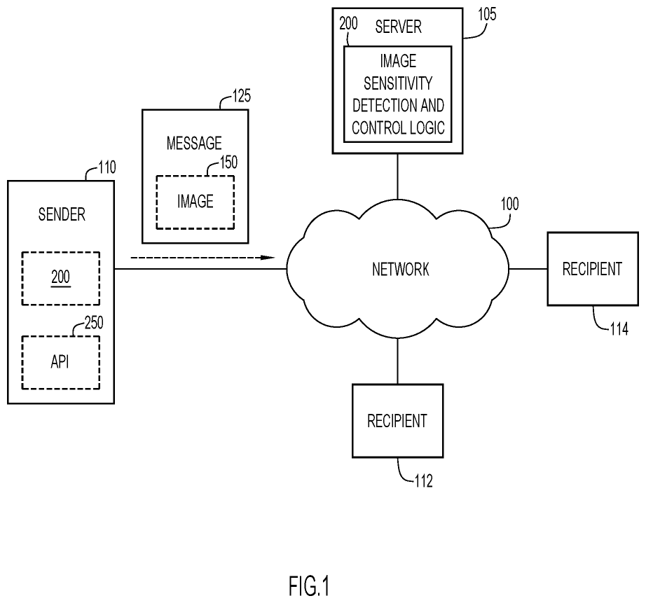

FIG. 1 shows several nodes, interconnected by an electronic network 100, including one node, e.g., server 105 that hosts image sensitivity detection and control logic 200, according to an example embodiment. Specifically, the figure shows a sender 110, a recipient 112, and a recipient 114. Sender 110 may also host image sensitivity detection and control logic 200, or at least have connectivity, via, e.g., an application programming interface, or API 250, to image sensitivity detection and control logic 200 operating on server 105. In a typical use case, sender 110 may want to send a message 125 (e.g., an email) with an embedded or attached image 150, such as a PNG or PDF file, to one or both of recipient 112 and recipient 114.

Image 150 could include sensitive information (e.g., inappropriate content, classified or confidential information, a password, medical record information, etc.) of which sender 110 may or may not be aware. The embodiments described herein, and particularly image sensitivity detection and control logic 200, are configured to detect the presence of sensitive information (or at least a probability of its presence), and, in response, compel, or at least suggest, at least some sort of governance on, or control over, the proliferation of that image.

### Detecting Sensitive Images

In accordance with an embodiment, sensitive information detection within image 150 may involve image sensitivity detection and control logic 200 running image 150 through one or multiple processes, each of which may provide a probability estimate that image 150 contains information that that process (or algorithm) is designed to identify as sensitive. Such processes may be executed directly by image sensitivity detection and control logic 200, or may be accessed by image sensitivity detection and control logic 200 via electronic network 100. Multiple different processes may be employed as images may be sensitive for any number of reasons, and hence implementations may exploit the use of multiple approaches to detect for sensitivity.

An example of a rule-based approach to identifying sensitive images of documents, passwords, etc., may be to run image 150 through an optical character recognition (OCR) operation and compare results to a library to identify text present in image 150, and then to estimate a likelihood that the text is of a sensitive nature based on a number of factors, which could include, but are not limited to:
The percentage of the image containing text
How centrally framed the text is in the image
The presence of certain words prejudged to be sensitive, such as medical or legal terms, or words such as “password” or “code”
The presence of numbers with currency signs and other financial terms, etc.
The presence of non-dictionary words that resemble passwords or numeric codes in their formation

The output of such an OCR process and library comparison may be a probability that image 150 contains sensitive data or information.

Alternatively, given a large corpus of labelled images that contain material of a certain type considered sensitive, a machine learning (ML)-based binary classifier could be trained to identify images as sensitive.

To identify inappropriate content (e.g., nudity) in image 150, image sensitivity detection and control logic 200 may leverage a wide range of pre-existing libraries that can estimate, using a variety of techniques, whether an image contains that sort of sensitive content.

When multiple detection processes are used, their outputs may be combined in some fashion to produce a combined score. One example of such an approach is to take the highest value among the probabilities. For instance, an image that is rated as having a nudity probability of 0.01 and a sensitive text probability of 0.89 would have a “combined” sensitivity score of 0.89. Of course, in other examples, the probabilities could be added together, weighted, averaged, etc.

### When To Run Detection

Some image classifiers can be computationally expensive to run and hence can potentially delay the ability of sender 110 to send image 150, especially if the implementation involves a compete and deep scan before image 150 can be sent.

To avoid, or at least reduce, the delay, implementations can take a number of mitigating steps. For example, when multiple classifiers are employed, implementations can run those classifiers in parallel where possible, and to run the classifiers as soon as sender 110 selects an image to include in message 125, rather than waiting until sender 110 chooses to send message 125.

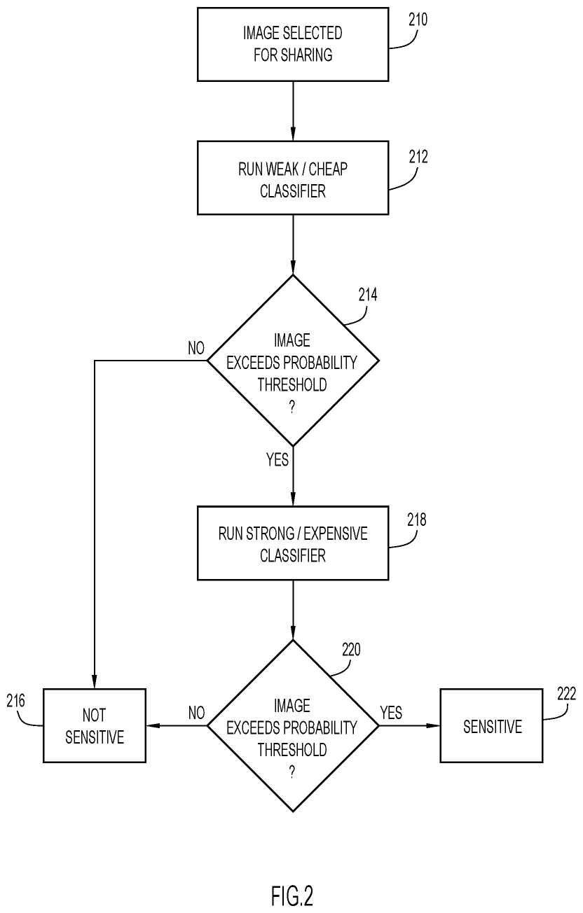

In another embodiment, it is possible to avoid or reduce delay by the detection approach shown in FIG. 2, which shows a flowchart illustrating a series of operations for detecting sensitive information in an image, according to an example embodiment. Specifically, at 210, image 150 is selected for sharing (e.g., sending). At 212, a relatively weaker or less expensive (computationally) classifier may be run on image 150. At 214, it is determined whether a threshold probability (e.g., 0.5, 0.7, 0.9, etc.) that image 150 includes sensitive information has been exceeded. If no, then at 216, image 150 is deemed not to include sensitive information. On the other hand, if, at 214, it is determined that the threshold probability that image 150 includes sensitive information has been exceeded then, at 218, a relatively stronger or more expensive (computationally) classifier is run on image 150. At 220, it is determined once again whether a threshold probability that image 150 includes sensitive information has been exceeded. If no, then, again, at 216, image 150 is deemed not to include sensitive information. On the other hand, if, at 220, it is determined that the threshold probability that image 150 includes sensitive information has been exceeded, then at 222, image 150 is deemed to include sensitive information and thus it may be desirable to apply, automatically, or to prompt sender 110 to apply, controls on the proliferation of image 150.

As a practical example, consider a scenario in which it is desired to determine if image 150 contains nudity. In such a case, image sensitivity detection and control logic 200 may be configured to run a computationally less expensive skin-tone classifier on image 150. If image 150 exceeds a predetermined confidence (probability) threshold on such an initial, quick-to-run classifier, then image sensitivity detection and control logic 200 may be configured to run a more accurate, but computationally more expensive, classifier (e.g., an ML-trained classifier). The computationally more expensive classifier need not be employed at all if the initial threshold is not met. Such an approach ensures that a majority of images can be quickly and cheaply identified as non-sensitive, while avoiding false positives by using a more accurate classifier on a minority of images that might contain sensitive information.

### Where To Run Detection

As shown in FIG. 1, in one implementation, image sensitivity detection and control logic 200 may run detection processes locally (e.g., on or at a computer of sender 110), but image sensitivity detection and control logic 200 may also be run in the cloud (e.g., by server 105. Cloud-based implementations can allow for potentially more powerful classifiers to be run without concerns for the CPU impact on low-powered clients, and/or to ensure that organizational policies are not being circumvented (this may be particularly important if the system has APIs that allow the development of non-native clients that may not otherwise adhere to such policies).

The operations of image sensitivity detection and control logic 200 may be executed as part of the delivery of message 125, or may be invoked separately by the client/computer of sender 110 prior to sending, by uploading image 150 for scanning via, e.g., API 250 and waiting for the result.

In implementations where cloud detection is performed after image 150 has been sent, image sensitivity detection and control logic 200 may be configured to notify, e.g., an email server, not to deliver message 125, and could also be configured to notify/alert sender 110 that message 125 contains a potentially sensitive image (and thus delivery of message 125 was stopped) and to allow them to take further action, e.g., resend the message, but with attachment/image controls.

In implementations where detection is performed on server 105 via, e.g., API 250, prior to sending, wherein it is also desirable to ensure that sender 110 is complying with organizational policies, then steps may be taken to ensure that the image being sent matches image 150 uploaded for sensitivity checking. This may be accomplished by entering a hash of image 150 into a database of approved images and ensuring that all shared images are present in such a database, or by providing a token to sender 110 that algorithmically demonstrates that approval has been granted. In the latter case, an algorithm may be configured to include a hash of image 150 to ensure that sender 110 is sharing the same image that was approved.

### Taking Action

When sender 110 takes an action to share image 150 for which image sensitivity detection and control logic 200 has estimated a probability of sensitivity that exceeds a predetermined threshold, image sensitivity detection and control logic 200 may be configured to present to sender 110 a prompt before message 125 is sent or shared, to query sender 110 as to whether they wish to take additional (anti-) proliferation or control steps. Such control steps could include limiting the actions recipient 112 and/or recipient 114 can take (assuming the application supports such controls on the receiving side) such as not allowing saving of image 150, detecting that a screenshot of image 150 has been taken, auto-deleting image 150 after viewing or after a predetermined period of time, or choosing not to share at all (i.e., allowing sender 110 to delete image 150 from message 125 prior to sending).

Image sensitivity detection and control logic 200 may be configured to allow organizations to configure policies that prevent any sharing of sensitive images, or which mandate that certain additional protections or controls are to be applied to the image 150. Such policies could be implemented on the client, i.e., a computer of sender 110 and/or at server 105, as part of the sending process.

Image sensitivity detection and control logic 200 may also be configured to apply different thresholds, behaviors, or controls based on the number of participants who are receiving an image. For instance, image sensitivity detection and control logic 200 might not allow images identified as sensitive to be sent to groups, but may allow sending to a single recipient, especially if such a recipient is on an allow list.

In some implementations, image sensitivity detection and control logic 200 may enable a “do not ask me again” option in a prompt such that sender 110 need not expressly permit sharing every single (potentially) sensitive image. These permissions might apply to individual persons/systems to which images are shared, and/or to particular types of sensitive images (e.g., images evaluated as likely to contain medical records versus images evaluated as likely to contain passwords).

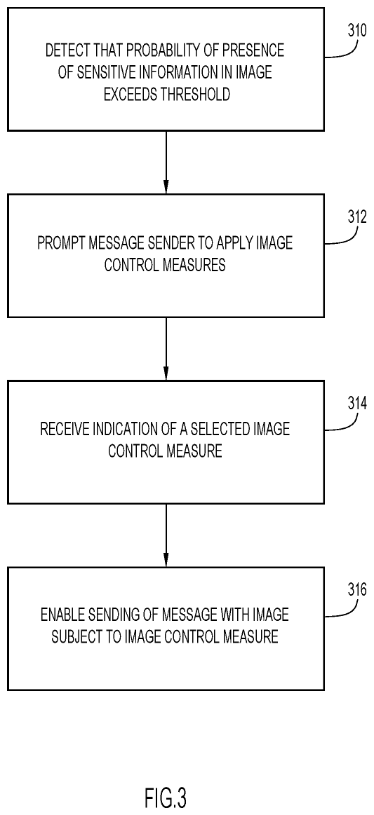

FIG. 3 is a flowchart illustrating a series of operations for prompting a sender to apply a security or control measure to an image being sent via an electronic message, according to an example embodiment. At 310, image sensitivity detection and control logic 200 detects that the probability of the presence of sensitive information in an image exceeds a predetermined threshold. At 312, in response to that detection, image sensitivity detection and control logic 200 prompts the message sender to apply image control measures to the image. Such a prompt may be overlaid in an email application via, e.g., a plug in, or via an instant messaging application, for example. At 314, image sensitivity detection and control logic 200 receives an indication of a selected image control measure. And at, 316, image sensitivity detection and control logic 200 enables sending of the message with the image subject to the selected image control measure.

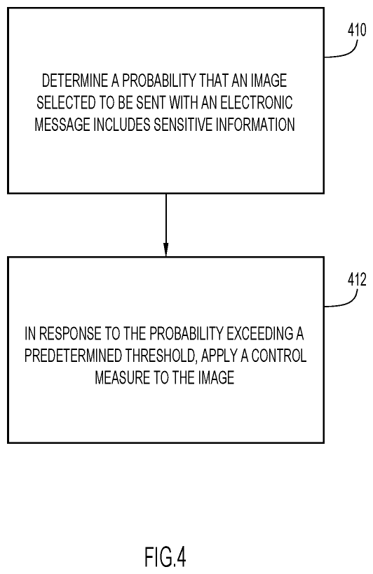

FIG. 4 is a flowchart illustrating a series of operations executed by image sensitivity detection and control logic, according to an example embodiment. At 410, an operation is configured to determine a probability that an image selected to be sent with an electronic message includes sensitive information. And, at 412, an operation is configured to, in response to the probability exceeding a predetermined threshold, apply a control measure to the image.

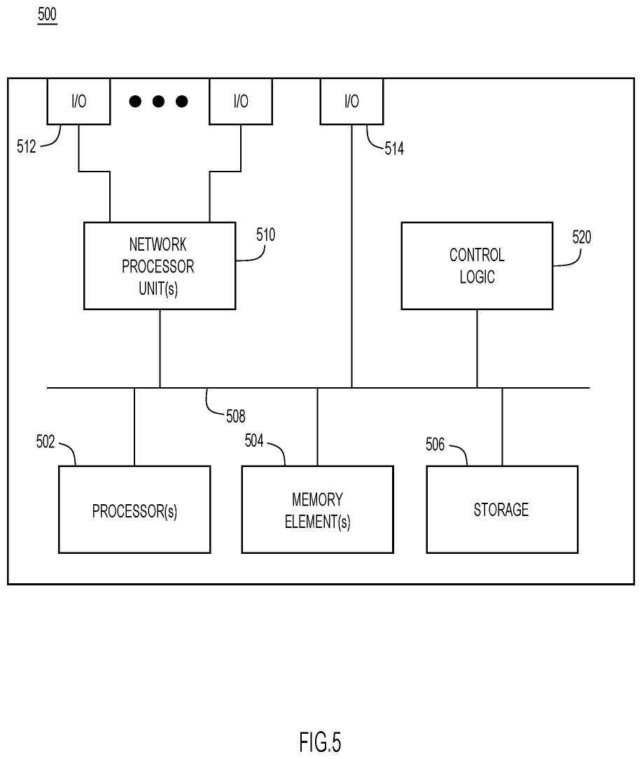

FIG. 5 is a block diagram of a computing device that may be configured to execute image sensitivity detection and control logic 200 and perform the techniques described herein, according to an example embodiment. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520 (which could include, for example, image sensitivity detection and control logic 200. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and’ one or more of can be represented using the ‘(s)’ nomenclature (e.g., one or more element(s)).

In sum, a method may include determining a probability that an image selected to be sent with an electronic message includes sensitive information, and in response to the probability exceeding a predetermined threshold, applying a control measure to the image.

In the method, determining the probability may include analyzing the image using at least one of an optical character recognition process or a nudity detection process.

In the method, determining the probability may include aggregating results of different sensitive information detection processes through which the image is processed.

In the method, determining the probability may include processing the image through different sensitive information detection processes in parallel with one another.

In the method, determining the probability may include processing the image with a first, less computationally expensive, classifier, and then a second, more computationally expensive, classifier.

In the method, determining the probability may include processing the image with a machine learning classifier.

The method may further include displaying a prompt via which to select the control measure.

In the method, the control measure may include prohibiting a recipient of the electronic message from saving the image.

In the method, the control measure may include causing the image to be automatically deleted after a predetermined period of time.

In the method, determining the probability may be performed with a cloud computing infrastructure.

In another embodiment, a device may be provided and may include an interface configured to enable network communications, a memory, and one or more processors coupled to the interface and the memory, and configured to: determine a probability that an image selected to be sent with an electronic message includes sensitive information, and in response to the probability exceeding a predetermined threshold, apply a control measure to the image.

In the device, the one or more processors may be configured to determine the probability by analyzing the image using at least one of an optical character recognition process or a nudity detection process.

In the device, the one or more processors may be configured to determine the probability by aggregating results of different sensitive information detection processes through which the image is processed.

In the device, the one or more processors may be configured to determine the probability by processing the image through different sensitive information detection processes in parallel with one another.

In the device, the one or more processors may be configured to determine the probability by processing the image with a first, less computationally expensive, classifier, and then a second, more computationally expensive, classifier.

In the device, the one or more processors may be configured to determine the probability by processing the image with a machine learning classifier.

In the device, the one or more processors may be configured to display a prompt via which to select the control measure.

In yet another embodiment, one or more non-transitory computer readable storage media encoded with instructions are provided and that, when executed by a processor, cause the processor to: determine a probability that an image selected to be sent with an electronic message includes sensitive information, and in response to the probability exceeding a predetermined threshold, apply a control measure to the image.

The one or more non-transitory computer readable storage media may include instructions that are further configured to determine the probability by analyzing the image using at least one of an optical character recognition process or a nudity detection process.

The one or more non-transitory computer readable storage media may include instructions that are further configured to determine the probability by processing the image with a first, less computationally expensive, classifier, and then a second, more computationally expensive, classifier.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
determining a probability that an image selected to be sent with an electronic message includes sensitive information; and
in response to the probability exceeding a predetermined threshold, applying a control measure to the image.

2. The method of claim 1, wherein determining the probability includes analyzing the image using at least one of an optical character recognition process or a nudity detection process.

3. The method of claim 1, wherein determining the probability includes aggregating results of different sensitive information detection processes through which the image is processed.

4. The method of claim 1, wherein determining the probability includes processing the image through different sensitive information detection processes in parallel with one another.

5. The method of claim 1, wherein determining the probability includes processing the image with a first, less computationally expensive, classifier, and then a second, more computationally expensive, classifier.

6. The method of claim 1, wherein determining the probability includes processing the image with a machine learning classifier.

7. The method of claim 1, further comprising displaying a prompt via which to select the control measure.

8. The method of claim 1, wherein the control measure comprises prohibiting a recipient of the electronic message from saving the image.

9. The method of claim 1, wherein the control measure comprises causing the image to be automatically deleted after a predetermined period of time.

10. The method of claim 1, wherein determining the probability is performed with a cloud computing infrastructure.

11. A device comprising:
an interface configured to enable network communications;
a memory; and
one or more processors coupled to the interface and the memory, and configured to:
determine a probability that an image selected to be sent with an electronic message includes sensitive information; and
in response to the probability exceeding a predetermined threshold, apply a control measure to the image.

12. The device of claim 11, wherein the one or more processors are configured to determine the probability by analyzing the image using at least one of an optical character recognition process or a nudity detection process.

13. The device of claim 11, wherein the one or more processors are configured to determine the probability by aggregating results of different sensitive information detection processes through which the image is processed.

14. The device of claim 11, wherein the one or more processors are configured to determine the probability by processing the image through different sensitive information detection processes in parallel with one another.

15. The device of claim 11, wherein the one or more processors are configured to determine the probability by processing the image with a first, less computationally expensive, classifier, and then a second, more computationally expensive, classifier.

16. The device of claim 11, wherein the one or more processors are configured to determine the probability by processing the image with a machine learning classifier.

17. The device of claim 11, wherein the one or more processors are configured to display a prompt via which to select the control measure.

18. One or more non-transitory computer readable storage media encoded with instructions that, when executed by a processor, cause the processor to:
determine a probability that an image selected to be sent with an electronic message includes sensitive information; and
in response to the probability exceeding a predetermined threshold, apply a control measure to the image.

19. The one or more non-transitory computer readable storage media of claim 18, wherein the instructions are further configured to determine the probability by analyzing the image using at least one of an optical character recognition process or a nudity detection process.

20. The one or more non-transitory computer readable storage media of claim 18, wherein the instructions are further configured to determine the probability by processing the image with a first, less computationally expensive, classifier, and then a second, more computationally expensive, classifier.
